(19) United States
(12) Patent Application Publication
(10) Pub. No.: US 2018/0362705 A1
(43) Pub. Date: Dec. 20, 2018

(54) PROCESS FOR MAKING POLYBUTYLENE TEREPHTHALATE WITH HIGH MOLECULAR WEIGHT AND HIGH CARBOXYLIC END GROUP CONCENTRATION

(71) Applicant: SABIC Global Technologies B.V., Bergen op Zoom (NL)

(72) Inventors: Husnu Alp ALIDEDEOGLU, Newburgh, IN (US); Prashant KUMAR, Evansville, IN (US)

(21) Appl. No.: 15/736,844

(22) PCT Filed: Jun. 3, 2016
(86) PCT No.: PCT/EP2016/062714

§ 371 Date: Dec. 15, 2017

Related U.S. Application Data
(60) Provisional application No. 62/181,544, filed on Jun. 18, 2015.

(51) Int. Cl. C08G 63/183; C08G 63/85

(52) U.S. Cl. CPC C08G 63/183; C08G 63/85

(57) ABSTRACT

Disclosed are improved processes for making high molecular weight polybutylene terephthalate resin. The PBT resin has a number average molecular weight of 30000 and 55000 g/mol, an IV of between 1.10 and 1.25 dl/g and a carboxylic acid end group concentration of between 35 and 70 mmol/kg. The PBT resin is prepared from PBT oligomers having an intrinsic viscosity of between 0.10 and 0.13 dl/g and a CEG of between 80 and 110 mmol/kg. The oligomers are prepared from purified terephthalic acid and 1,4-butane diol in the presence of a catalyst.

### FIELD OF THE INVENTION

Disclosed are improved processes for making high molecular weight polybutylene terephthalate (PBT) resin. The PBT resin has a number average molecular weight of between 30000 and 55000 g/mol, an intrinsic viscosity (IV) of between 1.10 and 1.25 dl/g and a carboxylic acid end group concentration (CEG) of between 35 and 70 mmol/kg. The PBT resin is prepared from PBT oligomers having an IV of between 0.10 and 0.13 dL/g and a carboxylic acid end group concentration of between 80 and 110 mmol/kg The oligomers are prepared from purified terephthalic acid (PTA) and 1,4-butane diol (BDO) in the presence of a catalyst.

### BACKGROUND OF THE INVENTION

PBT resins are semicrystalline thermoplastics used in a variety of durable goods. PBT resins are now widely used for components in the electronics and automotive industries. As these market sectors continue to expand and evolve, demand for PBT has continued to grow. Thus, in 2009, worldwide consumption of PBT was reported to total 750 kilotons. Demand for PBT is projected to increase at least 5 percent per year, leading to a projected demand of 1300 kilotons by the year 2020.

PBT producers continue to face the challenge of meeting increasing demand for PBT while dealing with higher production costs. One approach to improving process yield and reducing cost on an industrial scale relates to using PBT oligomer to make PBT resins. PBT oligomer can be prepared from PTA and BDO. To be useful in making PBT resin for specific end purposes, it is necessary to strictly control the carboxylic acid end group concentration CEG and intrinsic viscosity (IV) values of the PBT oligomer. PBT oligomers consisting of high carboxylic acid end group concentration (greater than 100 mmol/kg) are valuable for thermoset and composite applications due to the high carboxylic acid functionality. These oligomers are also important intermediates for making PBT via either a continuous or batch processes. Undesirable side reactions such as backbiting and thermal degradation limit the quality of the PBT oligomers for further processing. When thermal degradation and backbiting occur, the molecular weight increase of PBT is reduced.

As a result, there remains a need for new and improved processes for making PBT resins from PBT oligomer with desired molecular weight (MW), IV, and CEG values.

### SUMMARY OF THE INVENTION

These and other needs are met by the present invention which is directed to a process for preparing polybutylene terephthalate (PBT), comprising:
combining PBT oligomer containing 0.1 to 100 ppm tetra(C₁-C₈alkyl) titanate catalyst with 0.1 to 300 ppm tetra(C₁-C₈alkyl) titanate catalyst, wherein the PBT oligomer has an intrinsic viscosity (IV) of 0.10 to 0.13 dl/g and a carboxylic end group content (CEG) of 80 to 110 mmol/kg to form a mixture;
heating the mixture to a temperature of 245-255° C. and a pressure of 133 to 533 Pa (1 to 4 mm Hg) for a sufficient time to provide the PBT, wherein the PBT has a number average molecular weight (Mr) of between 30000 and 55000 g/mol, an IV of between 1.10 and 1.25 dl/g and a CEG of between 35 and 65 mmol/kg;

wherein the intrinsic viscosity is determined in accordance with in accordance with ASTM D2857-95 (2007), the carboxylic end group content is determined in accordance with ASTM D7409-15, and the number average molecular weight is determined in accordance with ASTM D6474-12.

The PBT oligomer may for example be a polymer comprising units derived from 1,4-butanediol and terephthalic acid, and have an intrinsic viscosity (IV) of 0.10 to 0.13 dl/g and a carboxylic end group content (CEG) of 80 to 110 mmol/kg. The PBT oligomer may comprise 0.1 to 100 ppm tetra(C₁-C₈alkyl) titanate catalyst, alternatively 10 to 90 ppm, alternatively 30 to 80 ppm. The tetra(C₁-C₈ alkyl) titanate catalyst that is present in the PBT oligomer may for example be selected from tetraisopropyl titanate, tetraisobutyl titanate, tetra tert-butyl titanate, tetraphenyl titanate, tetraethylhyxyl titanate, bis(alkanediolato) titanates or combinations thereof. Preferably, the tetra(C₁-C₈ alkyl) titanate catalyst is tetraisopropyl titanate.

In the process according to the present invention, 0.1 to 300 ppm tetra(C₁-C₈alkyl) titanate catalyst may be added to the PBT oligomer, alternatively 10 to 250 ppm, alternatively 30 to 200 ppm or 40 to 150 ppm. The tetra(C₁-C₈ alkyl) titanate catalyst that may be added to the PBT oligomer may for example be selected from tetraisopropyl titanate, tetraisobutyl titanate, tetra tert-butyl titanate, tetraphenyl titanate, tetraethylhyxyl titanate, bis(alkanediolato) titanates or combinations thereof. Preferably, the tetra(C₁-C₈ alkyl) titanate catalyst is tetraisopropyl titanate.

The PBT oligomer may for example have a carboxylic end group content (CEG) of 80 to 110 mmol/kg, alternatively 85 to 105 mmol/kg, alternatively 90 to 100 mmol/kg. For example, the PBT oligomer has an IV of 0.10 to 0.12 dl/g and a CEG of 85 to 105 mmol/kg

The PBT obtained via the process of the present invention may for example have a number average molecular weight of between 30000 and 55000 g/mol, alternatively between 35000 and 50000 g/mol, alternatively between 40000 and 45000 g/mol. The PBT may have an intrinsic viscosity of between 1.10 and 1.25 dl/g, alternatively between 1.12 and 1.20 dl/g, alternatively between 1.13 and 1.18 dl/g. the PBT may have a carboxylic end group content of between 35 and 65 mmol/kg, alternatively between 40 and 60 mmol/kg.

In a certain embodiment, the invention also relates to a process for preparing high molecular weight and high CEG PBT, comprising:

combining PBT oligomer containing 0.1 to 100 ppm tetra(C₁-C₈alkyl) titanate catalyst with 0.1 to 300 ppm tetra(C₁-C₈alkyl) titanate catalyst, wherein the PBT oligomer has an intrinsic viscosity (IV) of 0.10 to 0.13 dL/g and a CEG of 80 to 110 mmol/kg to form a mixture;

heating the mixture at approximately 245-255° C. and a pressure of 133 to 533 Pa (1 to 4 mm Hg) for a sufficient time to provide the PBT;

wherein the resulting PBT has an 30000 and 55000 number average molecular weight, an IV of between 1.10 and 1.25 dl/g and a high CEG between 35 and 65 mmol/kg.

In a particular embodiment of the invention, the applicants have surprisingly and unexpectedly found that PBT having a 30000 and 55000 number average molecular weight, an IV of between 1.10 and 1.25 dl/g and a CEG between 35 and 65 mmol/kg can be achieved at a higher melting temperature of between 250 and 255° C. and a lower residence time between 180 and 125 minutes. A pressure of between 133 to 533 Pa (1 to 4 mm Hg) does not affect CEG for the PBT having these characteristics.

The advantages of the new process includes reduced energy consumption needed to produce the PBT as well as the generation of PBT resins with lower variable cost of manufacturing. In addition, using PTA instead of DMT to make PBT has been shown to give rise to highly pure tetrahydrofuran (THF), a by-product of the PBT synthesis process with commercial and strategic downstream value.

In a certain embodiment, the process comprises heating the mixture comprising PBT oligomer and tetra(C₁-C₈alkyl) titanate catalyst to a temperature of 250-255° C., a pressure of 133 to 533 Pa (1 to 4 mm Hg), and a time of 125 and 180 minutes; wherein the resulting PBT has a number average molecular weight of between 30000 and 55000 g/mol, an IV of between 1.10 and 1.25 dl/g and a CEG of between 35 and 65 mmol/kg. The mixture may be kept at such temperature of 250-255° C. and pressure of 133 to 533 Pa (1 to 4 mm Hg) for a time between 125 and 180 minutes, preferably between 140 and 160 minutes.

The PBT oligomer that is introduced into the process of the present invention may be flaked, particulate or chunked.

The tetra(C₁-C₈alkyl) titanate catalyst used in the process according to the present invention for the production of PBT from a PBT oligomer preferably is tetra isopropyl titanate (TPT).

Further, the invention includes embodiments where the process also comprises the production of the PBT oligomer. For example, the process of the invention may further comprise preparing the PBT oligomer by heating a 2.5:1 to 3.5:1 molar ratio mixture of 1,4-butane diol (BDO) and terephthalic acid (PTA) in the presence of 0.1 to 300 ppm tetra(C₁-C₈alkyl) titanate catalyst to 230 to 280° C. at atmospheric pressure for a sufficient time to achieve an IV of 0.10 to 0.13 dl/g and a CEG of 80 to 110 mmol/kg. The tetra(C₁-C₈alkyl) titanate catalyst used to prepare the PBT oligomer may for example be selected from tetraisopropyl titanate, tetraisobutyl titanate, tetra tert-butyl titanate, tetraphenyl titanate, tetraethylhyxyl titanate, bis(alkanediolato) titanates or combinations thereof. Preferably, the tetra(C₁-C₈ alkyl) titanate catalyst used to prepare the PBT oligomer is tetraisopropyl titanate. The molar ratio of BDO to PTA to prepare the PBT oligomer preferably is 2.75:1 to 3.25:1 and preferably 30 to 150 ppm TPT catalyst is present. The temperature to prepare the PBT oligomer preferably is 240 to 270° C., alternatively 245 to 265° C., alternatively 245 to 260° C.

Further, an embodiment of the invention relates to a process for preparing PBT comprising:
preparing a PBT oligomer by heating a 2.5:1 to 3.5:1 molar ratio mixture of BDO and PTA in the presence of 0.1 to 300 ppm tetra(C₁-C₈alkyl) titanate catalyst to 230 to 280° C. at atmospheric pressure for a sufficient time to achieve an IV of 0.10 to 0.13 dl/g and a CEG of 80 to 110 mmol/kg;
combining the PBT oligomer having an intrinsic viscosity (IV) of 0.10 to 0.13 dl/g and a CEG of 80 to 110 mmol/kg with 0.1 to 300 ppm tetra(C₁-C₈alkyl) titanate catalyst to form a mixture;
heating the mixture to a temperature of 245-255° C. and a pressure of 133 to 533 Pa (1 to 4 mm Hg) for a sufficient time to provide the PBT, wherein the PBT has a number average molecular weight (Mr) of between 30000 and 55000 g/mol, an IV of between 1.10 and 1.25 dl/g and a CEG of between 35 and 65 mmol/kg.

For example, in this process, the mixture may be preferably heated to a temperature of 250-255° C., a pressure of 133 to 533 Pa (1 to 4 mm Hg), and reacted for a time of 125 and 180 minutes; the resulting PBT preferably has a number average molecular weight of between 30000 and 55000 g/mol, an IV of between 1.10 and 1.25 dl/g and a CEG of between 35 and 65 mmol/kg. Also in this process, the tetra(C₁-C₈alkyl) titanate catalyst used to prepare the PBT oligomer preferably is TPT. The molar ratio of BDO to PTA to prepare the PBT oligomer preferably is 2.75:1 to 3.25 and preferably 30 to 150 ppm TPT catalyst is present. It is preferred that the temperature to prepare the PBT oligomer is 240 to 270° C.

An embodiment of the present invention also relates to polybutylene terephthalate produced according to the process of the present invention.

### DETAILED DESCRIPTION OF THE INVENTION

If a term in the present application contradicts or conflicts with a term in a reference, the term in the present application takes precedence over the conflicting term from the reference. All ranges disclosed herein are inclusive of the endpoints, and the endpoints are independently combinable with each other. The use of the terms “a” and “an” and “the” and similar referents in the context of describing the invention (especially in the context of claims) are to be construed to cover both the singular and the plural, unless otherwise indicated herein or clearly contradicted by context. It should further be noted that the terms “first,” “second,” and the like herein do not denote any order, quantity, or importance, but rather are used to distinguish one element from another. The modifier “approximately” used in connection with a quantity is inclusive of the stated value and has the meaning dictated by the context (that is, it includes the degree of error associated with measurement of the particular quantity). As used herein all percent by weights are based on the total weight of the composition.

### PBT Oligomer

In the processes disclosed herein, PBT resin having a 30000 and 55000 number average molecular weight, an IV of between 1.10 and 1.25 dl/g and a CEG between 35 and 65 mmol/kg is prepared from PBT oligomer. The PBT oligomer that is used to prepare the PBT resin has an IV of between 0.10 and 0.13 dL/g and CEG of 80 mmol/kg and 110 mmol/kg.

PBT oligomer is prepared by reacting terephthalic acid with 1,4-butane diol (BDO) in the presence of a catalyst. Various grades of terephthalic acid may be used, but purified terephthalic acid (PTA) is preferred. Purified PTA is commercially available from a number of vendors and typically contains 10 percent of less of impurities as measured using conventional techniques. Typically, BDO and PTA are combined in a molar ratio of 6:1 to 2:1 in the presence of a catalyst such as of tetra(C₁-C₈alkyl) titanate such as tetraisopropyl titanate (TPT). To achieve an IV of 0.10 and 0.13 dL/g and CEG of 80 mmol/kg and 110 mmol/kg, a BDO to PTA ratio of 2:1 is employed. To achieve an IV of approximately 0.13-0.17 dl/g and a CEG of between 90 and 180 mmol/kg, a BDO to PTA ratio of 3:1 is employed. Alternatively, to achieve an IV of 0.25-0.43 dl/g and a CEG of lower than 20 mmol/kg, a BDO to PTA ratio of 4:1 is employed. The molar ratio of BDO to PTA will vary depending on the desired IV and CEG of the resulting PBT oligomer.

In one embodiment, 0.1 to 300 ppm tetra(C₁-C₈alkyl) titanate catalyst is used. In one embodiment, 0.1 to 100 ppm tetra(C₁-C₈alkyl) titanate catalyst is used.

In one embodiment, 0.1 to 200 ppm TPT catalyst is used. In one embodiment, 0.1 to 100 ppm TPT catalyst is used.

To make PBT oligomer, the components BDO, PTA, and TPT are combined and heated to a temperature of approximately 160° C. to 180° C. When the temperature of the reaction mixture is in the range of approximately 160° C. to 180° C., the temperature is gradually raised to approximately 220° C. to 265° C. Ester interchange occurs at approximately 230° C. to 260° C., and is complete when the clearing point is reached based on visual inspection. As used herein the “clearing point” occurs when the reaction medium becomes homogeneous melt. After the clearing point is reached, the pressure is optionally adjusted reduced to about 6.6 to 101 kPa (50 to 760 mm Hg) and the temperature is maintained at about approximately 230° C. to 260° C. for sufficient time to achieve desired IV and CEG values in the resulting PBT oligomer. At the completion of the reaction, the pressure is returned to atmospheric pressure and the polymer is analyzed. The resulting PBT oligomer, which contains the catalyst, can be cooled to a solid, then flaked, powdered, or pelletized, and is used to make PBT resin.

In one embodiment, the PBT oligomer contains 0.1 to 300 ppm tetra(C₁-C₈alkyl) titanate catalyst. In one embodiment, the PBT oligomer contains 0.1 to 100 ppm tetra(C₁-C₈alkyl) titanate catalyst.

In one embodiment, the PBT oligomer contains 0.1 to 300 ppm TPT catalyst. In one embodiment, the PBT oligomer contains 0.1 to 100 ppm TPT catalyst.

In one example, a reactor such as a helicone reactor having sufficient capacity may be used to prepare PBT oligomer. The reactor is equipped with blades for mixing. The reactor also includes an overhead condenser to condense the vapors in the esterification, transesterification (if any) and polymerization stages. In the process, 6.8 kg (41.0 mol) of PTA, 11.1 kg (123.0 mol) of BDO, and 9.0 ml of TPT are combined in the reactor at 170° C. under a nitrogen atmosphere. The agitator speed is set at 67% of maximum. The temperature is raised to 240° C. The ester interchange (EI) reaction is run until the clearing point is observed (visual point where the homogeneous melt was achieved). The entire EI stage is carried out under complete reflux mode; that is, during the EI stage, the condensed overhead from the reactor was allowed to reflux back to the reactor. The reaction temperature is then increased to 260° C. and the reaction is run under atmospheric pressure. After the clearing point is reached and a sufficient time passes to achieve an IV of 0.10 and 0.13 dL/g and CEG of 80 mmol/kg and 110 mmol/kg is achieved, the oligomer melt containing TPT is dropped on an aluminum pan and grinded into fine particles.

In another example, a pilot plant set-up may be used to prepare PBT oligomer. At the start of each batch, preheated BDO from a BDO storage tank was transferred to the 757 l (200 gallon) oligomerization reactor under vacuum at 100° C. During this stage a hot oil unit was activated to increase and control the temperature of the reactor. The inlet oil temperature was set between 265 and 300° C. The desired PTA load was introduced into the reactor by man-way addition opening. After the PTA addition, the man-way addition was sealed and the temperature was allowed to increase. The reactor stirrer was set at 40 Hertz. When the reactor temperature reached 170° C., TPT catalyst mixed with BDO was charged into the reactor via the catalyst charge pot. The overhead column setting was set to allow the overheads from the reactor to condense and collect in the receiver pot. The temperature readings from each thermocouple were manually recorded in the log sheet by the operator every 30 to 45 minutes during each batch production run. When the reactor temperature reached the desired temperature, for example 248-250° C., the hot oil set-point was decreased to prevent the temperature to increase beyond 252° C. Extensive sampling was performed to measure IV and CEG. At the desired IV and CEG the reactor temperature was decreased using hot oil having a temperature of 225 to 230° C. to reduce the reactor temperature to 225 to 230° C. When the reactor temperature reached 225 to 230° C., the agitation was stopped and the inlet hot oil temperature was increased to 240° C. to prepare for dropping the material from the reactor and terminating the batch. A belt flaker with cooling river water spraying at the bottom of the belt was switched on. A pressure of 34 kPa (5 psi) was applied to the reactor to drop the material from the reactor to the belt flaker.

The belt flaker was set at approximately 907±113 kg/hour (2000±250 lbs/hour) to drop the entire batch in approximately 3±0.5 hours. The flaked oligomer from the flaker was transferred to 454 kg (1000 pound) super-sacs for storage and cooling. Once the oligomers cooled, a grinder was used to grind the flaked chunks into fine powder. PBT oligomer containing TPT catalyst was obtained, having an IV of between 0.10 and 0.13 dl/g and CEG of between 80 mmol/kg and 110 mmol/kg.

### PBT Resin

PBT resin may be prepared from the PBT oligomer prepared as described above. As indicated previously, the amount of catalyst in the PBT oligomer may be between 0.1 and 300 ppm or between 0.1 to 100 ppm. The PBT oligomer may have an intrinsic viscosity (IV) of between 0.10 to 0.13 dl/g and a carboxylic acid end group concentration CEG of 80 to 110 mmol/kg.

Additional TPT catalyst typically 0.1 to 300 ppm, may be added to the PBT oligomer. The resulting mixture is heated to approximately 245-255° C. and a pressure of 133 to 533 Pa (1 to 4 mm Hg) for a sufficient time to provide the PBT resin. The resulting PBT resin may have a number average molecular weight of between 30000 and 55000 g/mol, an IV of between 1.10 and 1.25 dl/g and a CEG of between 35 and 65 mmol/kg.

A reactor such as a helicone reactor having sufficient capacity can be used to prepare PBT having a number average molecular weight of between 30000 and 55000 g/mol, an IV of between 1.10 and 1.25 dl/g and a CEG between 35 and 65 mmol/kg from PBT oligomer having an IV of between 0.10 and 0.13 dL/g and CEG of 80 mmol/kg and 110 mmol/kg.

In one embodiment, a 10 CV (Cone Vertical) Helicone reactor having a capacity of 56.8 l (15 gallons) and equipped with twin opposing helical blades with 270 degree twist is used. The blades are constructed of 316 SS (Stainless Steel) with a 16 g polish finish is used for the preparation of the PBT oligomers. The blade speed can be varied from 1 to 65 rpm (revolutions per minute). The agitators are connected to a constant torque inverter duty motor, which operates at 230/460 VAC, and 60 Hz. The bowl is a double intersecting cone-type designed for 1.03 MPa (150 psig) positive pressure or vacuum to 26.6 Pa (0.2 mm Hg) at a temperature of 232° C. (450° F.). The vessel is equipped with baffled jacketing to permit uniform circulation of heating and cooling medium at a pressure of 0.70 MPa (100 psig). The interior of the mix chamber is constructed of 316 SS with 16 g polish finish throughout and built in accordance with ASME code. These agitators provide excellent surface area for the polymer melt to build molecular weight. The Helicone reactor is also designed with an overhead condenser to condense the (BDO/THF/H₂O) vapors in the esterification, trans-esterification (if any), and polymerization stages. A federov valve is used to sample polymer melt and oligomers from the reaction medium during atmospheric pressure and under reduced reactor pressure.

In one example, 25 pounds of the PBT oligomer and 16 mL of TPT catalyst diluted with 2 lbs of BDO were fed into the reactor. The agitator speed was set at 60% of maximum. The reaction was allowed to occur for sufficient temperature, pressure, and time to provide the PBT resin.

In one embodiment, the reaction pressure is 133 to 533 Pa (1 to 4 mm Hg).

In one embodiment, the reaction temperature is 250 to 255° C.

In one embodiment, the reaction time is 120 to 185 minutes.

In one embodiment, the reaction pressure is 133 to 533 Pa (1 to 4 mm Hg); and the reaction temperature is 250 to 255° C.

In one embodiment, the reaction pressure is 133 to 533 Pa (1 to 4 mm Hg); the reaction temperature is 250 to 255° C.; and the reaction time is 120 to 185 minutes.

In one embodiment, the resulting PBT has a CEG of between 38 and 65 mmol/kg.

In one embodiment, the resulting PBT has a CEG of 40 to 50 mmol/kg.

In one embodiment, the resulting PBT has a CEG of 42 to 48 mmol/kg.

In one embodiment, the resulting PBT has a CEG of 45 to 47 mmol/kg.

In one embodiment, the resulting PBT has a CEG of 46 mmol/kg.

In one embodiment, the resulting PBT has an IV of between 1.10 and 1.25 dl/g and a CEG.

The invention is further described in the following illustrative examples in which all parts and percentages are by weight unless otherwise indicated.

### EMBODIMENTS

### Embodiment 1

A process for preparing high molecular weight and high CEG polybutylene terephthalate (PBT), comprising:

combining PBT oligomer containing 0.1 to 100 ppm tetra(C₁-C₈alkyl) titanate catalyst with 0.1 to 300 ppm tetra(C₁-C₈alkyl) titanate catalyst, wherein the PBT oligomer has an intrinsic viscosity (IV) of 0.10 to 0.13 dL/g and a CEG of 80 to 110 mmol/kg to form a mixture;

heating the mixture at approximately 245-255° C. and a pressure of 133 to 533 Pa (1 to 4 mm Hg) for a sufficient time to provide the PBT,

wherein the resulting PBT has a 30000 and 55000 number average molecular weight, an IV of between 1.10 and 1.25 dl/g and a high CEG between 35 and 65 mmol/kg.

### Embodiment 2

The process of Embodiment 1, comprising heating the mixture at approximately 250-255° C., a pressure of 133 to 533 Pa (1 to 4 mm Hg), and a time of 125 and 180 minutes; wherein the resulting PBT has a 30000 and 55000 number average molecular weight, an IV of between 1.10 and 1.25 dl/g and a high CEG between 35 and 65 mmol/kg.

### Embodiment 3

The process of Embodiments 1-2, wherein the PBT oligomer is flaked, particulate, or chunked.

### Embodiment 4

The process of Embodiments 1-3, wherein the tetra(C₁-C₈alkyl) titanate catalyst is tetra isopropyl titanate (TPT).

### Embodiment 5

The process of Embodiments 1-4, wherein the PBT oligomer has an intrinsic viscosity (IV) of 0.1 to 0.12 dL/g and a CEG of 85 to 105 mmol/kg.

### Embodiment 6

The process of Embodiments 1-5, further comprising preparing the PBT oligomer by heating a 2.5:1 to 3.5:1 molar ratio mixture of 1,4-butane diol (BDO) and terephthalic acid (PTA) in the presence of 0.1 to 300 ppm tetra(C₁-C₈alkyl) titanate catalyst to 230 to 280° C. at atmospheric pressure for a sufficient time to achieve an intrinsic viscosity (IV) of 0.10 to 0.13 dL/g and a CEG of 80 to 110 mmol/kg.

### Embodiment 7

The process of Embodiment 6 wherein the tetra(C₁-C₈alkyl) titanate catalyst used to prepare the PBT oligomer is TPT.

### Embodiment 8

The process of Embodiment 7, wherein the molar ratio of BDO to PTA to prepare the PBT oligomer is 2.75:1 to 3.25:1 and 30 to 150 ppm tetraisopropyl titanate catalyst is present.

### Embodiment 9

The process of Embodiment 8, wherein the molar ratio of BDO to PTA to prepare the PBT oligomer is a 2.9:1 to 3.1:1.

### Embodiment 10

The process of Embodiments 7-9 wherein the temperature to prepare the PBT oligomer is 240 to 270° C.

### Embodiment 11

A process for preparing polybutylene terephthalate (PBT), comprising:

preparing PBT oligomer by heating a 2.5:1 to 3.5:1 molar ratio mixture of 1,4-butane diol (BDO) and terephthalic acid (PTA) in the presence of 0.1 to 300 ppm tetra(C₁-C₈alkyl) titanate catalyst to 230 to 280° C. at atmospheric pressure for a sufficient time to achieve an IV of 0.10 to 0.13 dL/g and a CEG of 80 to 110 mmol/kg;

combining PBT oligomer having an intrinsic viscosity (IV) of 0.10 to 0.13 dL/g and a CEG of 80 to 110 mmol/kg with 0.1 to 300 ppm tetra(C₁-C₈alkyl) titanate catalyst to form a mixture;

heating the mixture at approximately 245-255° C. at a pressure of 133 to 533 Pa (1 to 4 mm Hg) for a sufficient time to provide PBT having a 30000 and 55000 number average molecular weight, an IV of between 1.10 and 1.25 dl/g and a CEG between 35 and 65 mmol/kg.

### Embodiment 12

The process of Embodiment 11, comprising: heating the mixture at approximately 250-255° C., a pressure of 133 to 533 Pa (1 to 4 mm Hg), and a time of 125 and 180 minutes; wherein the resulting PBT has a 30000 and 55000 number average molecular weight, an IV of between 1.10 and 1.25 dl/g and a high CEG between 35 and 65 mmol/kg.

### Embodiment 13

The process of Embodiments 11-12, wherein the tetra(C₁-C₈alkyl) titanate catalyst used to prepare the PBT oligomer is tetraisopropyl titanate (TPT).

### Embodiment 14

The process of Embodiments 11-13, wherein the molar ratio of BDO to PTA to prepare the PBT oligomer is 2.75:1 to 3.25 and 30 to 150 ppm TPT catalyst is present.

### Embodiment 15

The process of Embodiment 14, wherein the molar ratio of BDO to PTA to prepare the PBT oligomer is 2.9:1 to 3.1:1.

### Embodiment 16

The process of Embodiments 11-15, wherein the temperature to prepare the PBT oligomer is 240 to 270° C.

### Embodiment 17

The process of Embodiments 11-16, wherein the PBT oligomer has an IV of 0.11 to 0.12 dL/g and a CEG of 85 to 105 mmol/kg.

### EXAMPLES

The following examples illustrate the scope of the invention. The examples and preparations which follow are provided to enable those skilled in the art to more clearly understand and to practice the present invention. They should not be considered as limiting the scope of the invention, but merely as being illustrative and representative thereof.

The example present certain process conditions to operate a batch process suitable to produce PBT having a number average molecular weight of between 30000 and 55000 g/mol, an IV of between 1.10 and 1.25 dl/g and a CEG of between 35 and 70 mmol/kg from PBT oligomers having an IV of between 0.10 and 0.13 dL/g and a CEG of between 80 and 110 mmol/kg.

### Materials

1,4-Butanediol (BDO) was obtained from BASF having a purity specification of 99.5 weight percent. TPT catalyst (commercial Tyzor grade) was obtained from Dorf Ketal. PTA (terephthalic acid) was obtained from Eastman Chemical Company.

### Process Description: Oligomer Preparation in 200 Gallon Reactor

At the start of each batch, preheated BDO from BDO storage tank was transferred to a 757 l (200 gallon) oligomerization reactor under vacuum at 100° C. During this stage a hot oil unit was activated to increase and control the temperature of the reactor thermocouple for the reactor temperature. The inlet oil temperature was set between 265 and 300° C. The desired PTA load was introduced into the reactor. After the PTA addition, reactor was sealed and the temperature was allowed to increase. The reactor stirrer was set at 40 Hertz. When the reactor temperature reached 170° C., TPT catalyst mixed with BDO was charged into the reactor. The overhead column setting was set to allow the overheads from the reactor to condense and collect in the receiver pot. The temperature readings from each thermocouple were manually recorded in the log sheet by the operator every 30 to 45 minutes during each batch production run. When the reactor temperature reached the desired temperature as indicated in Table 1, the hot oil set-point was decreased to prevent the reactor temperature to increase beyond 252° C. Extensive sampling was performed to measure IV and CEG. At the desired IV and CEG, the reactor temperature was decreased using hot oil having a temperature of 225 to 230° C. to reduce the reactor temperature to 225 to 230° C. When the reactor temperature reached 225 to 230° C., the agitation was stopped and the inlet hot oil temperature was increased to 240° C. to prepare for dropping the material from the reactor and terminating the batch. A belt flaker with cooling river water spraying at the bottom of the belt was switched on. A pressure of 34.5 kPa (5 psi) was applied to the reactor to drop the material from the reactor to the belt flaker. The belt flaker was set at approximately 907±113 kg/hour (2000±250 lbs/hour) to drop the entire batch in approximately 3±0.5 hours. The flaked oligomer from the flaker was transferred to 454 kg (1000 pound) super-sacs for storage and cooling. Once the oligomers cooled, a grinder was used to grind the flaked chunks into fine powder.

### Process Description: Oligomer Preparation in Helicone Reactor

A 10 CV (Cone Vertical) Helicone reactor having a capacity of 56.8 l (15 gallons) was used. The Helicone reactor was equipped with twin opposing helical blades with 270 degree twist. The blades were constructed of 316 SS (stainless steel) with a 16 g polish finish. The blade speed could be varied from 1 to 65 rpm (revolutions per minute). The agitators were connected to a constant torque inverter duty motor, which operates at 230/460 VAC, and 60 Hz. The bowl was a double intersecting cone-type designed for 1.034 MPa (150 pounds per square inch (gauge)) or vacuum to 26.6 Pa (0.2 mm Hg) at a temperature of 232° C. (450° F.). The vessel was equipped with baffled jacketing to permit uniform circulation of the heating and cooling medium at a pressure of 0.70 MPa (100 psig). The interior of the mix chamber was constructed of 316 SS with 16 g polish finish throughout and built in accordance with ASME code. These agitators provided excellent surface area for the polymer melt to build molecular weight. The Helicone reactor was also designed with an overhead condenser to condense the (BDO/THF/H₂O) vapors in the esterification, trans-esterification (if any), and polymerization stages. A federov valve was used to sample polymer melt and oligomers from the reaction medium during atmospheric pressure and under reduced reactor pressure.

PBT oligomers having an IV of between 0.10 and 0.13 dL/g and CEG of 80 mmol/kg and 110 mmol/kg were batch prepared in the Helicone reactor from 6.8 kg (41.0 mol) of PTA, 11.1 kg (123.0 mol) of BDO, and 9.0 ml of TPT at 170° C. under a nitrogen atmosphere. The BDO to PTA mole ratio was equal to 3:1. The agitator speed was set at 67% of maximum. The temperature was raised to 240° C. The ester interchange (EI) reaction was run until the clearing point was observed (visual point where the homogeneous melt was achieved). The entire EI stage was carried out under complete reflux mode; that is, during the EI stage, the condensed overhead from the reactor was allowed to reflux back to the reactor.

The reaction temperature was then increased to 260° C. and the reaction was run under atmospheric pressure until the desired IV and CEG were achieved. The oligomer melt was dropped on an aluminum pan and grinded into fine particles. The ground oligomer was used for the lab batch polymerization process.

### PBT Production

The PBT grades were prepared by feeding 11.3 kg (25 lbs) of PBT oligomers having an IV of between 0.10 and 0.13 dL/g and CEG of between 80 mmol/kg and 110 mmol/kg, and 16 ml of TPT catalyst diluted with 0.91 kg (2 lbs) of BDO. The agitator speed was set at 60% of maximum. The oligomer and catalyst mixture were reacted in the Helicone reactor as described previously, using conditions as set out in table 1.

A response surface of CEG of PBT was explored using a 3 level factorial design. The process variables were the PBT melt temperature, reactor pressure, and the polycondensation residence time to achieve the desired molecular weight, IV, and CEG characteristics (30000 and 55000 g/mol number average molecular weight PBT polymers having an IV of between 1.10 and 1.25 dl/g and a CEG of between 35 and 70 mmol/kg). The process variables for each run are given in Table 1.

TABLE 1
PBT Design of Experiment for CEG

| | | Factor 1: | Factor 2: | | Factor 3: |
|---|---|---|---|---|---|
| Batch | | Melt Temperature | Pressure | | Residence Time |
| Number | Run | (° C.) | Pa | (MmHg) | (min) |
| 13 | 1 | 250 | 333 | (2.5) | 160 |
| 1 | 2 | 245 | 133 | (1) | 180 |
| 6 | 3 | 255 | 333 | (2.5) | 150 |
| 11 | 4 | 250 | 333 | (2.5) | 140 |
| 7 | 5 | 245 | 533 | (4) | 230 |
| 4 | 6 | 245 | 333 | (2.5) | 230 |
| 10 | 7 | 250 | 333 | (2.5) | 150 |
| 8 | 8 | 250 | 533 | (4) | 190 |
| 5 | 9 | 250 | 333 | (2.5) | 140 |
| 12 | 10 | 250 | 333 | (2.5) | 170 |
| 3 | 11 | 255 | 133 | (1) | 130 |
| 9 | 12 | 255 | 533 | (4) | 160 |
| 2 | 13 | 250 | 133 | (1) | 140 |

### General Testing of PBT:

The IV of PBT was measured using an automatic Viscotek Microlab® 500 series Relative Viscometer Y501. 0.5 grams of oligomer sample was fully dissolved in a 60:40 mixture (% volume) of phenol and 1,1,2,2-tetrachloroethane solution (Harrell Industries). Two measurements were taken for each sample, and the reported result was the average of the two measurements.

The CEG of PBT was measured using Metrohm-Autotitrator including Titrando 907, 800 Dosino, 2 ml and 5 ml dosing units and 814 USB sample processor. All the units are controlled from a PC using Tiamo 2.0 Full version. 1.5-2.0 grams of oligomer was fully dissolved in 50 ml of 0-cresol solvent at 80° C. After dissolving, the sample was cooled to room temperature and 50 ml of 0-cresol and 1 ml of water were added to the beaker. Sample blank was prepared in the similar way. The electrodes and titrant dosing system were dipped into the sample solution and the titration was started. The sample titration was repeated twice and the equivalence point was noted for the calculation of CEG value. The CEG was calculated as: CEG (mmol/kg)=(ml consumed by sample−ml consumed by the blank)*N of NaOH*1000.

### Results and Discussion

The interaction between IV and the process parameters are well known. The IV of the PBT melt increases linearly with the increase of the residence time. The batch pilot plant is capable of monitoring the IV of the PBT melt through the motor power at different stage agitator speed. This allows us to meet the IV specs for every step of the design of experiment (DOE) and to produce a DOE that explores the response surface for CEG by applying a three level factorial design. The three factors are melt temperature (245, 250, 255° C.), pressure (133, 333, 533 Pa) (1, 2.5, 4 mmHg), and residence time (140, 190, 240 min). The Response 1 of the resulting DOE is the CEG (mmol/kg). The details of DOE and Response 1 are listed in Table 2.

TABLE 2
Design of Experiment Results

| | | Response 1: |
|---|---|---|
| | | CEG |
| Batch Number | Run | (mmol/kg) |
| 13 | 1 | 66 |
| 1 | 2 | 126 |
| 6 | 3 | 66 |
| 11 | 4 | 52 |
| 7 | 5 | 70 |
| 4 | 6 | 57 |
| 10 | 7 | 57 |
| 8 | 8 | 64 |
| 5 | 9 | 55 |
| 12 | 10 | 55 |
| 3 | 11 | 46 |
| 9 | 12 | 72 |
| 2 | 13 | 58 |

The experiments demonstrate that a PBT having a number average molecular weight of between 30000 and 55000 g/mol, an IV of between 1.10 and 1.25 dl/g and a CEG of between 35 and 65 mmol/kg grade may be produced using is a melting temperature between 250 and 255° C. and low residence time between 180 and 125 min.

1. A process for preparing polybutylene terephthalate (PBT), comprising:
combining a PBT oligomer containing 0.1 to 100 ppm tetra(C₁-C₈ alkyl) titanate catalyst with 0.1 to 300 ppm tetra(C₁-C₈ alkyl) titanate catalyst, wherein the PBT oligomer has an intrinsic viscosity (IV) of 0.10 to 0.13 dl/g and a carboxylic end group content (CEG) of 80 to 110 mmol/kg to form a mixture;
heating the mixture to a temperature of 245-255° C. and a pressure of 133 to 533 Pa (1 to 4 mm Hg) for a sufficient time to provide the PBT, wherein the PBT has a number average molecular weight (MO of between 30000 and 55000 g/mol, an IV of between 1.10 and 1.25 dl/g and a CEG of between 35 and 65 mmol/kg;
wherein the intrinsic viscosity is determined in accordance with in accordance with ASTM D2857-95 (2007), the carboxylic end group content is determined in accordance with ASTM D7409-15, and the number average molecular weight is determined in accordance with ASTM D6474-12.

2. The process of claim 1, comprising: heating the mixture to a temperature of 250-255° C., a pressure of 133 to 533 Pa (1 to 4 mm Hg), and a time of 125 and 180 minutes; wherein the resulting PBT has a number average molecular weight of between 30000 and 55000 g/mol, an IV of between 1.10 and 1.25 dl/g and a CEG of between 35 and 65 mmol/kg.

3. The process of claim 1, wherein the PBT oligomer is flaked, particulate, or chunked.

4. The process of claim 1, wherein the tetra(C₁-C₈ alkyl) titanate catalyst is tetra isopropyl titanate (TPT).

5. The process of claim 1, wherein the PBT oligomer has an IV of 0.10 to 0.12 dL/g and a CEG of 85 to 105 mmol/kg.

6. The process of claim 1, further comprising preparing the PBT oligomer by heating a 2.5:1 to 3.5:1 molar ratio mixture of 1,4-butane diol (BDO) and terephthalic acid (PTA) in the presence of 0.1 to 300 ppm tetra(C₁-C₈ alkyl) titanate catalyst to 230 to 280° C. at atmospheric pressure for a sufficient time to achieve an IV of 0.10 to 0.13 dl/g and a CEG of 80 to 110 mmol/kg.

7. The process of claim 6, wherein the tetra(C₁-C₈ alkyl) titanate catalyst used to prepare the PBT oligomer is tetraisopropyl titanate (TPT).

8. The process of claim 7, wherein the molar ratio of BDO to PTA to prepare the PBT oligomer is 2.75:1 to 3.25:1 and 30 to 150 ppm TPT catalyst is present.

9. The process of claim 8, wherein the temperature to prepare the PBT oligomer is 240 to 270° C.

10. A process for preparing PBT according to claim 1, comprising:
preparing a PBT oligomer by heating a 2.5:1 to 3.5:1 molar ratio mixture of BDO and PTA in the presence of 0.1 to 300 ppm tetra(C₁-C₈ alkyl) titanate catalyst to 230 to 280° C. at atmospheric pressure for a sufficient time to achieve an IV of 0.10 to 0.13 dl/g and a CEG of 80 to 110 mmol/kg;
combining the PBT oligomer having an intrinsic viscosity (IV) of 0.10 to 0.13 dl/g and a CEG of 80 to 110 mmol/kg with 0.1 to 300 ppm tetra(C₁-C₈ alkyl) titanate catalyst to form a mixture;
heating the mixture to a temperature of 245-255° C. and a pressure of 133 to 533 Pa (1 to 4 mm Hg) for a sufficient time to provide the PBT, wherein the PBT has a number average molecular weight (MO of between 30000 and 55000 g/mol, an IV of between 1.10 and 1.25 dl/g and a CEG of between 35 and 65 mmol/kg.

11. The process of claim 10, comprising: heating the mixture to a temperature of 250-255° C., a pressure of 133 to 533 Pa (1 to 4 mm Hg), and a time of 125 and 180 minutes; wherein the resulting PBT has a number average molecular weight of between 30000 and 55000 g/mol, an IV of between 1.10 and 1.25 dl/g and a CEG of between 35 and 65 mmol/kg

12. The process of claim 11, wherein the tetra(C₁-C₈ alkyl) titanate catalyst used to prepare the PBT oligomer is TPT.

13. The process of claim 12, wherein the molar ratio of BDO to PTA to prepare the PBT oligomer is 2.75:1 to 3.25 and 30 to 150 ppm TPT catalyst is present.

14. The process of claim 13, wherein the temperature to prepare the PBT oligomer is 240 to 270° C.

15. Polybutylene terephthalate produced according to the process of claim 1.

16. Polybutylene terephthalate produced according to the process of claim 10.
